(19) United States
(12) Patent Application Publication
(10) Pub. No.: US 2026/0147477 A1
(43) Pub. Date: May 28, 2026

(54) MEMORY MAPPING FOR MICRO-SCALING NUMERICS FORMAT

(71) Applicant: Meta Platforms, Inc., Menlo Park, CA (US)

(72) Inventors: Zhaoxia Deng, San Mateo, CA (US); Xianliang Zha, El Dorado Hills, CA (US); Junqiang Lan, Fremont, CA (US); Rohan Prakash Mallya, Fremont, CA (US); Yunqing Chen, Los Altos, CA (US); Xing Cindy Chen, Los Altos, CA (US); Mohammad Janani, San Jose, CA (US); Nanda Unnikrishnan, Sunnyvale, CA (US)

(73) Assignee: Meta Platforms, Inc., Menlo Park, CA (US)

(21) Appl. No.: 19/396,788

(22) Filed: Nov. 21, 2025

Related U.S. Application Data
(60) Provisional application No. 63/724,106, filed on Nov. 22, 2024.
(60) Provisional application No. 63/723,988, filed on Nov. 22, 2024.
(60) Provisional application No. 63/724,028, filed on Nov. 22, 2024.
(60) Provisional application No. 63/723,801, filed on Nov. 22, 2024.

(51) Int. Cl. G06F 3/06

(52) U.S. Cl. CPC G06F 3/0608; G06F 3/064; G06F 3/0673

(57) ABSTRACT

Methods, systems, or apparatuses for storage and access of micro-scaling numerics (MX) format data in memory. The approach may involve organizing MX data into tiled formats that match the read capabilities of consuming hardware blocks, interleaving scaling data with floating-point data, storing floating-point data in raster scan order, and storing scaling data in sub-tiles packed in multiples of a memory line size. A constant product of tile x-size and format size may be maintained across different MX format sizes, ensuring consistent memory utilization. This method may affect memory management for MX format data.

### CROSS-REFERENCE TO RELATED APPLICATIONS

This application claims the benefit of the following applications: U.S. Application No. 63/724,106, filed Nov. 22, 2024, U.S. Application No. 63/723,988, filed Nov. 22, 2024, U.S. Application No. 63/724,028, filed Nov. 22, 2024, and U.S. Application No. 63/723,801, filed Nov. 22, 2024, each of which is incorporated by reference herein.

### TECHNOLOGICAL FIELD

The present disclosure relates generally to computer memory management and more specifically to techniques for storing and accessing micro-scaling numerics (MX) format data in memory. The present disclosure relates generally to computer arithmetic logic and more specifically to techniques for determining underflow conditions in micro-scaling (MX) floating-point number formats. The present disclosure relates to computer architecture and artificial intelligence, such as methods and systems associated with debuggability of micro-scaling numerics formats in floating-point computations. The present disclosure relates generally to computer arithmetic logic and more specifically to techniques for handling special values in block-based floating point formats.

### BACKGROUND

Floating-point formats represent real numbers in computers, allowing a wide range of values. They include a sign bit, exponent, and significand (mantissa). Common formats include single-precision (32-bit) and double-precision (64-bit). Floating-point enables scientific notation-like representation, balancing range and precision.

### SUMMARY

Techniques are disclosed for storing and accessing micro-scaling numerics (MX) format data in computer memory systems. In an example, a method, system, or apparatus may provide for organizing MX data into tiled formats that align with the read capabilities of consuming hardware blocks, thereby optimizing data access patterns and reducing memory bandwidth requirements. It also may incorporate a technique for interleaving scaling data with floating-point data, which may ensure that components of the MX format are readily accessible, thus minimizing data retrieval latency. A raster scan order may be implemented for storing floating-point data, which may facilitate sequential access and align with machine learning processing patterns.

The disclosed subject matter may address the challenge of detecting underflow in micro-scaling (MX) formats by providing for underflow detection. Underflow may be defined based on the overall value of a data element, considering the effects of the shared block scaler, and this value may be compared to a configurable minimum threshold. By also considering rounding errors, a more accurate and flexible approach may be provided to underflow detection in MX formats.

This approach may allow for effective error detection and handling in applications using MX formats, potentially improving the accuracy and reliability of machine learning implementations.

Techniques are disclosed associated with the debuggability of MX formats by defining canonical values for special numeric cases such as Infinity (Inf), Not a Number (NaN), zero, or normal data. These canonical values are user-definable and compliant with the given MX format. The disclosed subject matter may allow for flexible mapping of data, not limited to the mentioned values, and may be user-defined for different ranges or specific data values. This approach may enhance the interpretability of data inside NaN blocks, facilitating debugging and data analysis for developers.

Techniques are disclosed for handling special values in block-based floating point formats. In one aspect, when a block's shared scaling factor indicates the presence of special values, canonical bit patterns are assigned to each data element in the block to represent whether it is a normal value, zero, infinity, or Not-a-Number (NaN). This may allow for efficient storage and identification of special values while maintaining the block structure of the format.

In an example, a method, system, or apparatus may provide for receiving a block of data elements in a block-based floating point format, where the block includes a shared block scaling factor and multiple data elements. If the shared block scaling factor indicates the block includes at least one special value, the method may assign a canonical bit pattern to each data element based on whether it represents a normal value, zero, infinity, or NaN. The block may then be stored with these assigned canonical bit patterns.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

FIG. 1 illustrates an example of different floating point formats.

FIG. 2 illustrates an example MX format.

FIG. 3 illustrates an example FP8 format.

FIG. 4 illustrates an example of a disclosed memory mapping approach for MX format data which is further disclosed herein.

FIG. 5 illustrates an example method associated with a memory mapping approach for MX format data.

FIG. 6 is an example method for detecting underflow in micro-scaling formats.

FIG. 7 is an example method for debuggability of MX formats using canonical NaN block representations.

FIG. 8 illustrates an example of handling special values in a block-based floating point format.

FIG. 9 is an example method for handling special values in a block-based floating point format.

FIG. 10 illustrates an example block diagram of an exemplary computing device suitable for implementing aspects of the disclosed subject matter.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Floating point number formats are widely used in computer systems to represent real numbers. The IEEE 754 standard defines formats and methods for floating point arithmetic. However, new block-based floating point formats have been developed to improve performance for certain applications, particularly in machine learning (also referenced herein as artificial intelligence). One such format is the micro-scaling numerics (MX) format, which uses a shared block scaling factor for multiple data elements.

While these new formats offer advantages, they lack methods for how to efficiently pack data and scaling factors in memory. The present disclosure addresses a need for storing MX format data by providing methods and systems for efficient memory mapping and tiling. This approach may optimize data storage to match the read capabilities of consuming hardware blocks, interleave scaling data with floating-point data, or maintain consistent memory utilization across different MX format sizes. While the MX format offers advantages in terms of computational speed and memory usage, it presents challenges in detecting certain numerical conditions, such as underflow. In traditional floating-point formats, underflow is typically defined as occurring when a value falls into the subnormal range (e.g., tininess) and a rounding error occurs. However, this definition may not directly apply to MX formats due to the presence of the shared block scaler, which may make the overall magnitude of data appear larger than it actually is.

The present disclosure provides techniques for detecting underflow in MX formats. This approach considers the overall value of data elements and the occurrence of rounding errors, offering an accurate and flexible underflow detection mechanism.

The disclosed subject matter may address a gap in the MX floating-point standard by providing a system to represent and preserve debug information inside NaN blocks. This may be particularly important for formats such as MX4, which are designed for extreme efficiency and may not have built-in representations for special cases like Infinity (Inf) or Not a Number (NaN).

The process may include defining canonical values for various special cases. While a set of example mappings are provided herein, note that these mappings are flexible and can be user-defined to suit specific needs. When a value is encountered that may not be directly represented in the target MX format (such as NaN in MX4), the entire block may be set to NaN. However, instead of using a standard NaN representation, which may result in a loss of information, the specific encoding within the NaN block indicates the original value type. This may allow for the preservation of debugging information that may otherwise be lost in the conversion process.

While there are examples that include MX4 format, the concept may be applied to other MX formats as well. Furthermore, the user-defined nature of the mappings means that developers may create custom encodings for specific value ranges or other special cases that are particularly important for their applications.

While these new formats offer advantages, they lack standardized methods for handling and representing special values. This may make debugging and analysis of computations using these formats more difficult. There is a need for techniques to effectively handle special values in block-based floating point formats while maintaining their performance benefits.

The present disclosure provides techniques for handling special values in block-based floating point formats. These formats, such as the MicroXcaling (MX) format, offer performance advantages for certain applications but lack standardized methods for representing special values like infinity and Not-a-Number (NaN). The disclosed techniques may address this issue, such as by using canonical bit patterns to represent special values within the block structure of these formats.

Computer arithmetic, also known as digital arithmetic or machine arithmetic, refers to the methods used to perform numerical calculations in computing systems. It encompasses the hardware and software implementations of arithmetic operations on digital numbers, including integers and floating-point numbers. The techniques disclosed herein specifically address a subset of computer arithmetic related to floating-point representation and computation.

To understand the significance of the disclosed subject matter, it is important to first grasp the fundamentals of floating-point representation and the challenges associated with block-based floating point formats. Further consideration of such information is disclosed below.

Floating-point formats represent a significant aspect of computer arithmetic, employing exponent-linear scaling to handle a wide range of values. These formats use signed magnitude representation and may incorporate a multi-level scaling system: exponent scaling for a fixed base and significand-linear precision. Mathematically, a floating-point value may be expressed as (−1) raised to the sign, multiplied by 2 raised to the exponent, and then multiplied by the significand. While floating-point numbers offer lower precision compared to integers, they may provide a higher dynamic range due to the presence of the exponent.

In contrast, integer representations utilize a linear scale, typically employing 2's complement or unsigned representation. Integers may offer higher precision within their range but are limited in their dynamic range compared to floating-point numbers.

The IEEE 754 standard defines several floating-point formats, including Binary16 (half precision), Binary32 (single precision), Binary64 (double precision), and Binary128 (quad precision). Additionally, specialized formats have emerged for machine learning applications.

This distinction between floating-point and integer representations, along with the variety of floating-point formats, forms a foundation for efficient and flexible numerical computations in modern computing systems, catering to a wide array of applications from general-purpose calculations to specialized machine learning tasks.

A floating point representation example is shown below in Table 1.

TABLE 1

−9.375 = 0b 1_10010_0010100000 in FP16
Sign = 1
Bias = 15
Exponent = 18 (biased) or 3(unbiased)
Significand = 0b 1.0010100000

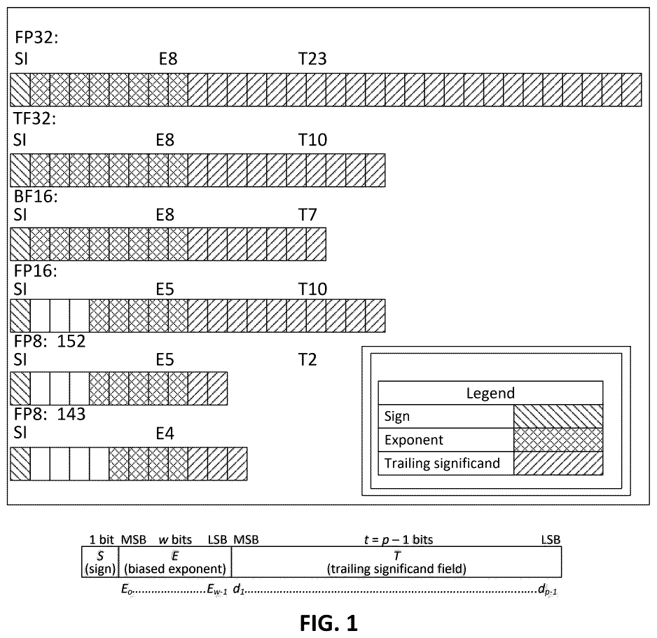

With reference to Table 1, the implicit bit of the significand is 1 and the Trailing significand is 0010100000. FIG. 1 illustrates an example of different floating point formats.

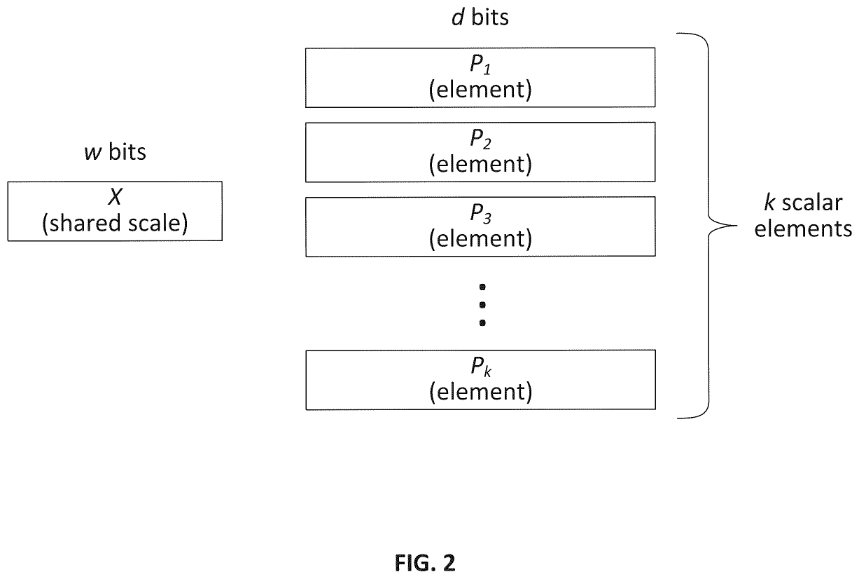

The MX (Micro X) format represents an approach to floating-point number representation, designed to enhance efficiency and flexibility in numerical computations. FIG. 2 illustrates an example MX format. K may be set to 32 by open compute project (OCP) standard. This format may organize data elements into blocks of 64 bytes, each featuring a shared block scalar. The block scalar, an 8-bit value stored with a bias of 127, may provide a common scaling factor for all elements within the block. This structure may allow for data elements of varying sizes—16, 32, or 64 bits (e.g., FP4/FP6/FP8)—to coexist within the same framework.

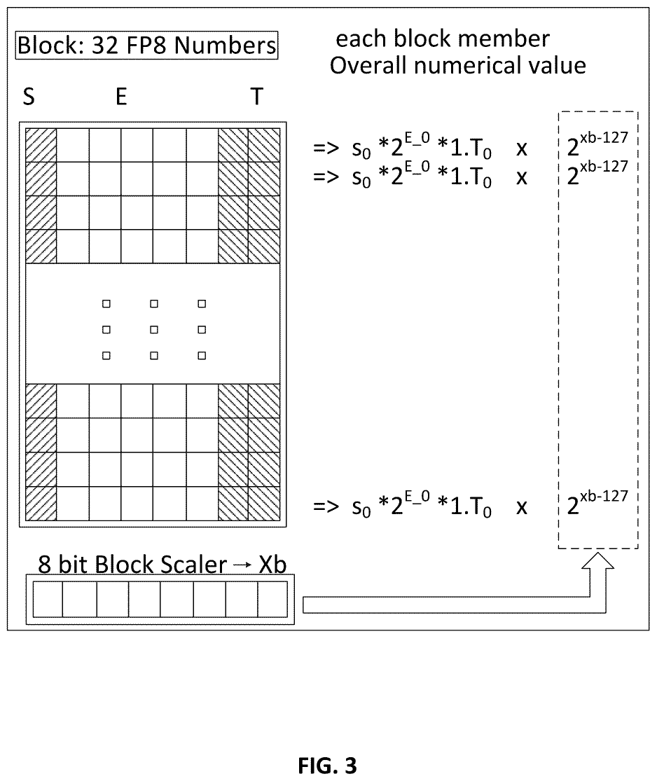

The MX format's architecture, as outlined in Table 2 may include multiple components. These may include a primary sign bit, a biased exponent field, a trailing significand field, the block-shared scale, and a field indicating the number of scalar elements per block. This design may enable a more nuanced representation of floating-point numbers, potentially offering advantages in certain computational scenarios. FIG. 3 illustrates an example FP8 format.

TABLE 2
MicroXcaling (MX) Components

| | | |
|---|---|---|
| Component | Width | Functionality |

Primary

| | | |
|---|---|---|
| S | 1 | Sign bit where 0 represents a positive |
| | | number and 1 represents a negative number |
| E | w | Biased exponent field |
| T | t | Trailing significand field |
| Xb | 8 | Block Shared scale |
| Kb | 32 | Number of scalar elements per block |

Table 3 details variants of the MX format: MX16, MX32, and MX64. Each variant may be characterized by specific parameters, including the bit allocation for various components and the range of representable values. These specifications, presented in Table 3 and Table 4, demonstrate the format's scalability and adaptability to different precision requirements. As shown in Table 4, MX4 NaN is only defined for the block when shared scaling Xb=255, e.g., all the data in the block are NaN; only in MX8_152 inf is defined.

TABLE 3

| Parameter | MX4 | MX8_143 | MX8_152 |
|---|---|---|---|
| k | 4 | 8 | 8 |
| M: p | 2 | 4 | 3 |
| T: t | 1 | 3 | 2 |
| E/X: w | 2 | 4 | 5 |
| F: i.f | 1.1 | 1.3 | 1.2 |
| ebias | 1 | 7 | 15 |
| emax | 2 | 8 | 15 |
| emin | 0 | −6 | −14 |
| Xb | 8 | 8 | 8 |
| Xumax | 127 | 127 | 127 |
| Xumin | −127 | −127 | −127 |
| Xbias | 127 | 127 | 127 |

TABLE 4

| | MX4 (121) | MX8_143 | MX8_152 |
|---|---|---|---|
| 0 | E = 0 | E = 0 | E = 0 |
| | T = 0 | T = 0 | T = 0 |
| Smallest | E = 0 | E = 0 | E = 0 |
| Subnormal | T = 1′b1 | T = 3′b001 | T = 2′b01 |
| Largest | E = 0 | E = 0 | E = 0 |
| Subnormal | T = 1′b1 | T = 3′b111 | T = 2′b11 |
| Smallest | E = 1 | E = 1 | E = 1 |
| Normal | T = 1′b | T = 3′b | T = 2′b |
| | 0 Xb = 0 | 0 Xb = 0 | 0 Xb = 0 |
| Largest | E = 3 | E = 15 | E = 30 |
| Normal | T = 1′b | T = 3′b11 | T = 2′b1 |
| Inf | N/A | N/A | E = 31 |
| | | | T = 2′b |
| NaN | N/A | E = 15 | E = 31 |
| | | T = 3′b111 | T = {2′b01, |
| | | | 2′b10, 2′b11} |
| Block NaN | Xb = 255 | Xb = 255 | Xb = 255 |

A notable feature of some MX formats is the handling of special values, such as Not a Number (NaN). As shown in Table 5, the format introduces the concept of “Block NaN,” where an entire block is considered NaN if the shared scaling block value (Xb) is 255, regardless of individual element values.

TABLE 5
Individual and Block NaN in MX

| NaN Type | MX4 | MX8_143 | MX8_153 |
|---|---|---|---|
| Individual NaN | N/A | E = 15 & | E = 31& |
| | | T = 7 | T = 1, 2, 3 |
| Block NaN | Xb = 255 | Xb = 255 | Xb = 255 |

The conventional MX format standard defines the data format and scalar size, yet several aspects remain unexplained. The conversion from traditional floating-point formats to MX has been described, but the handling of infinity or NaN (Not a Number) values during this process needs clarification. The method for deriving the block scalar also lacks detail. When a block becomes a NaN block, the representation of values within it remains undefined. The standard does not suggest canonical values for representing data, infinity, and NaN in these situations. Underflow in the MX format is unclear, as the subnormal range no longer indicates very small values due to potentially large block scalar values. The standard also omits discussion of MX maximum values potentially exceeding the maximum normal value of FP32. These unaddressed points in the MX format specification present opportunities for further development and standardization in subsequent revisions.

The MX format specification outlines block boundaries and intra-block operations. It may include the following components: the floating-point data and a power-of-2 block scaling factor. However, the specification lacks guidance on memory arrangement for data and scaling factors. From a hardware perspective, aligning data in tiles that correspond to resource dimensions may be advantageous. This approach may create a challenge regarding the allocation of unused tile regions. Conventional methods such as zero-padding become inefficient for larger tile sizes.

Further disclosed herein is an approach for storing MX format data in memory efficiently. The approach organizes MX data in a tiled format that matches the read capability of the consuming hardware block. A feature of this approach is the interleaving of scaling data with floating point data within the tile structure.

Further disclosed herein is an approach for assigning an appropriate scaling factor value to regions outside partial tiles, allowing their interpretation as real values rather than undefined ones. The method may involve multiple padding levels: padding to the MX block size (e.g., 32) and padding to the larger tile size. For the MX block size, data may be padded to 0, preserving the MX block's value. For tile padding, a scaling value such as 255 may be selected (the MX encoding for NaN in the scaling factor), ensuring data interpretation as NaN regardless of the data tile's contents. This technique may ensure that an undefined region in a partial tile is consistently interpreted as NaN, providing numerical safety and definition. It may reduce or eliminate the need to assign a safe value to the entire data tile, which may be prohibitively costly for large tiles.

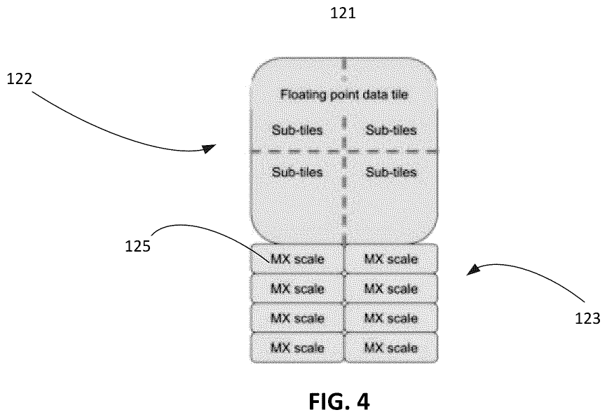

FIG. 4 illustrates an example of a disclosed memory mapping approach for MX format data which is further disclosed herein. Memory space 121 may be divided into two main sections: an area for storing floating-point data and an adjacent area for storing scaling data. The floating-point data section 122 may be organized into a grid-like pattern, symbolizing the tiled format used for efficient data access. Each tile within this grid represents a block of MX format data, arranged in a way that aligns with the read capabilities of the consuming hardware. The scaling data section 123 may be divided into sub-tiles 125. These sub-tiles 125 may be sized to match memory line sizes (e.g., 64 bytes), which may ensure efficient hardware access and addressing. The relative sizes of floating-point data section 122 and scaling data section 123 may reflect a certain ration (e.g., the 32:1 ratio commonly used in MX8 format). This ratio may vary depending on the specific MX format in use.

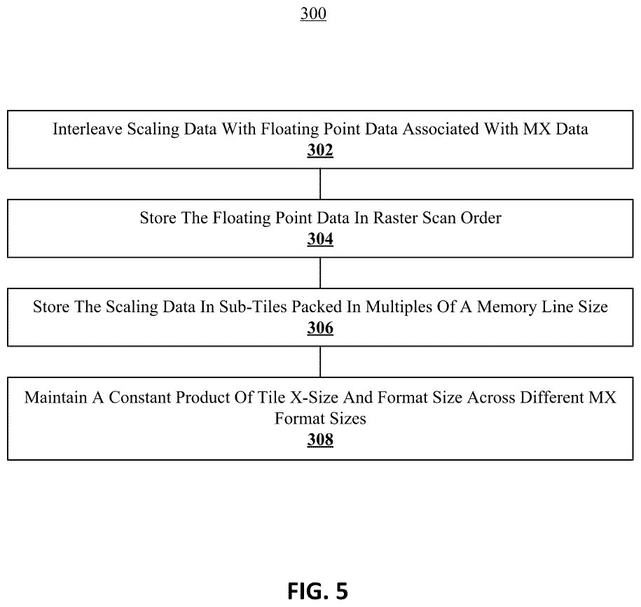

FIG. 5 illustrates an example method associated with a memory mapping approach for MX format data. At step 300, MX data may be organized into tiled formats. A processor may organize MX data into tiled formats that match the read capabilities of the hardware block. The tiled format may be defined by an x_size and y_size, which are multiples of block-tiles supported by the hardware. This organization may be a component of optimizing data access patterns and ensuring that the hardware may read data in chunks that align with its processing capabilities.

With continued reference to the concept of tiled format, each tile may represent a two-dimensional block of data, with dimensions that are chosen to match the capabilities of the hardware. For example, if the hardware block may efficiently process 128 data elements at a time, the x_size of the tile might be set to 128. The y_size is then chosen to create a tile that balances efficient storage with the ability of the hardware to handle multiple rows of data simultaneously. The use of tiled formats may allow for efficient memory access patterns, which may reduce the number of memory reads required to process a given amount of data. This may be particularly significant in machine learning applications, where the same data may be accessed multiple times during training or inference operations.

At step 302, scaling data may be interleaved with floating-point data. The processor may interleave the scaling data associated with the MX format with the floating-point data. This interleaving may allow for efficient access to components of the MX format. The MX format, as a compressed representation of floating-point numbers, may include the following components: the floating-point data itself and the scaling factors that allow for the reconstruction of the full-precision values.

At step 304, the floating-point data may be stored in raster scan order. The floating-point data may be stored in memory following a raster scan order, which may allow for efficient sequential access. This alignment may minimize cache misses and may reduce the overall memory bandwidth required for data access.

At step 306, the scaling data may be stored in sub-tiles. The scaling data may be stored in sub-tiles that are packed in multiples of the memory line size (e.g., 64 bytes). This approach may allow for efficient hardware access and addressing of partial tiles. Sub-tiles are introduced to handle the scaling data, which may typically be much smaller in volume compared to the floating-point data but significant for correct interpretation of the MX format.

By packing the scaling data into sub-tiles that align with memory line sizes, the system may ensure that scaling data may be accessed with minimal wasted memory bandwidth. For example, if the memory line size is 64 bytes, each sub-tile of scaling data may be designed to fit within one or more complete 64-byte lines. This alignment prevents scenarios where accessing a small amount of scaling data requires reading across multiple memory lines, which may be inefficient.

The use of sub-tiles also facilitates efficient addressing of partial tiles. In real-world scenarios, the data being processed may not perfectly fill complete tiles. By organizing scaling data into sub-tiles, the system may access the scaling information for partial tiles without needing to read unnecessary data.

At step 308, a constant product of tile x-size and format size may be maintained. A constant product of tile x-size and format size may be maintained across different MX format sizes. This may be achieved by adjusting the x-size inversely to changes in format size, which may ensure consistent memory utilization. This constant product may be maintained. For instance, if the MX format size is reduced from 1 byte to 0.5 bytes (perhaps moving from 8-bit to 4-bit precision), the x-size of the tiles may be doubled. This adjustment may ensure that the total amount of data included in each tile remains constant, regardless of the precision of the MX format being used.

As disclosed throughout, the examples may be adjusted based on the specific implementation. The tiled format disclosed herein may employ an x_size and y_size that are multiples of block-tiles. For instance, a 128×64 tile may comprise 64×32 sub-tiles. These block-tiles themselves may be multiples of the MX block format size, such as 32×1 for 1D MX blocks or 32×32 for 2D MX blocks. The choice of tile size may depend on multiple factors. Firstly, the tile size may align with the processing capabilities of the consuming hardware block; for example, if the hardware may process 128 elements in parallel, an x_size of 128 may be suitable. Secondly, the tile size may be selected to fit efficiently within the cache hierarchy of the system, allowing a whole number of tiles to fit within each cache level to minimize cache thrashing. Further, the tile size may be chosen to maximize utilization of the memory bus; for instance, if the memory bus is 512 bits wide, tile sizes that are multiples of 512 bits may be efficient.

With reference to interleaved data storage, scaling data may be interleaved with floating-point data, an arrangement that may allow for efficient access to both components when processing MX format data. The interleaving pattern may be customized based on the specific requirements of the consuming hardware block. Some possible interleaving strategies include block-level interleaving, where the scaling factor for a block of data is stored immediately before or after the block; row-level interleaving, where scaling factors for each row of data are stored at the end of the row; and distributed interleaving, where scaling factors are distributed throughout the data at regular intervals. The choice of interleaving strategy depends on factors such as the typical access patterns of the consuming hardware block and the relative sizes of the floating-point and scaling data.

With reference to constant memory utilization, the product of tile x-size and format size may remain constant. For example, if the format size is 0.5 bytes, the x_size might be 256, while for a format size of 1 byte, the x_size may be 128. This constant utilization may be achieved through a formula: x_size*format_size=constant, where x_size is the width of the tile in elements, format size is the size of each MX format element in bytes, and constant is a predetermined value chosen based on system characteristics. By maintaining this constant relationship, the system may ensure that the same amount of data is processed in each tile, regardless of the precision of the MX format being used.

With reference to efficient partial tile addressing, the storage of scaling data in sub-tiles packed in multiples of the memory line size (e.g., 64 bytes) may allow for efficient addressing of partial tiles. Partial tiles may occur when the data being processed does not perfectly fill a complete tile, which may happen at the edges of data sets or when dealing with irregularly shaped input data. The use of sub-tiles for scaling data may allow the system to efficiently access the scaling information for these partial tiles without needing to read unnecessary data. The addressing scheme for partial tiles may work as follows: the system maintains a lookup table or bit map indicating which sub-tiles include valid data; when accessing a partial tile, the system first consults this lookup table to determine which sub-tiles need to be read; then, only the necessary sub-tiles are accessed, minimizing unnecessary memory reads.

With reference to format agnostic tile size, by maintaining a constant product of x_size and format_size, the system ensures that tile sizes remain consistent across different MX format sizes, simplifying memory management. This format agnostic approach offers several advantages. Firstly, it allows for simplified hardware design, as the consuming hardware block may be designed to process tiles of a consistent size, regardless of the MX format being used. Secondly, it may provide flexible precision, enabling the system to easily switch between different MX format precisions without needing to reconfigure its memory management strategies. It may ensure consistent performance by maintaining a constant amount of data per tile, allowing the system to achieve more predictable performance across different MX format sizes. The disclosed subject matter works for every MX types stated in the standard which are MX4, MX6, or MX8 but may be expanded to any MXk format where k may be any number. MX block size that is mentioned in the standard may be a block of 32 but the disclosed may work for any block size of any 1-dimension and 2-dimension block sizes.

Methods, systems, or apparatus for storing micro-scaling numerics (MX) format data in memory are disclosed herein. A method, system, or apparatus may provide for interleaving scaling data with floating point data associated with MX data; storing the floating point data in raster scan order; and storing the scaling data in sub-tiles packed in multiples of a memory line size. The method may further include maintaining a constant product of tile x-size and format size across different MX format sizes. Accessing the MX data may be based on the storing of the floating point data and the storing of the scaling data. The tiled formats may comprise an x-size and a y-size that are multiples of block-tiles supported by the consuming hardware block, where the block-tiles are multiples of an MX block format size. The memory line size may be 64 bytes. The method may also include defining the smallest unit of memory supported by the consuming hardware block as a block-tile. The product of tile x-size and format size may remain constant by adjusting the x-size inversely to changes in format size. All combinations (including the removal or addition of steps) in this paragraph and the above paragraphs are contemplated in a manner that is consistent with the other portions of the detailed description.

A method, system, or apparatus may provide for storing micro-scaling numerics (MX) format data in memory which may include organizing MX data into tiled formats matching read capabilities of a consuming hardware block; interleaving scaling data with floating point data associated with the MX data; storing the floating point data in raster scan order; and storing the scaling data in sub-tiles packed in multiples of a memory line size. A method may include receiving data and storing the received data in a micro-scaling numerics (MX) format, wherein the MX format tiled format matches the read capability of a consuming block, and wherein scaling data is interleaved with floating point data associated with the received data. All combinations (including the removal or addition of steps) in this paragraph and the above paragraphs are contemplated in a manner that is consistent with the other portions of the detailed description.

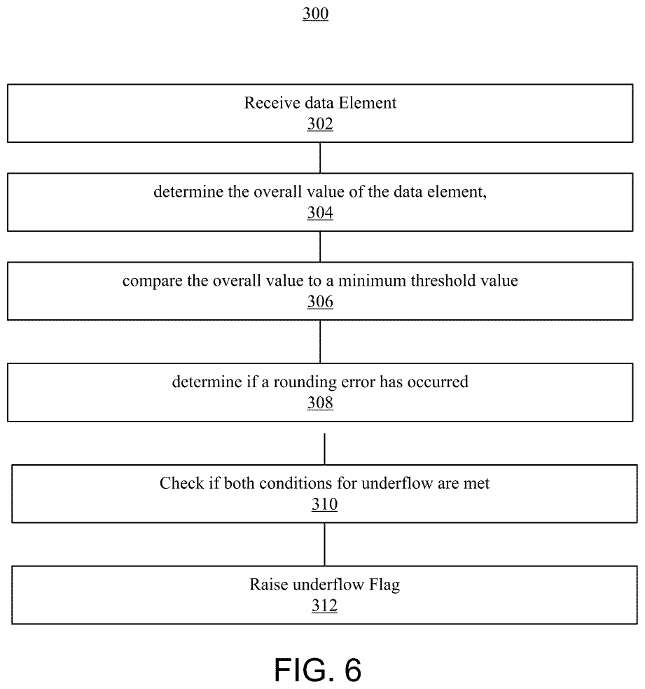

FIG. 6 illustrates a flowchart of a method 300 for detecting underflow in MX formats. The method begins at step 302 where the system receives a data element in MX format. In step 304, the system determines the overall value of the data element, taking into account the effects of the shared block scaler.

In step 306, the system compares the overall value to a minimum threshold value. This minimum threshold value may be determined based on various factors, such as the minimum unbiased shared block scaler value, an underflow definition for a 32-bit floating point format, or a combination of the lowest block scale value and the lowest data element exponent value. This minimum threshold value may be configured by the user or application, providing flexibility to adapt to different computational requirements.

Step 308 involves determining if a rounding error has occurred during the computation involving the data element. In step 310, the system checks if both conditions for underflow are met: whether the absolute value of the overall value is less than two times the minimum threshold value, and whether a rounding error has occurred.

If both conditions are met, the system indicates (e.g., raises) an underflow flag in step 312. If there is no condition met, the system does not raise the underflow flag.

Falling into the subnormal range in MX format does not necessarily indicate true tininess, as the shared block scaler may be quite large, potentially inflating the overall magnitude of the data beyond what it actually represents. This discrepancy necessitates a redefinition of underflow specifically tailored to the MX format to accurately capture and reflect instances of true tininess.

To address this issue, a new method for defining underflow in MX format is proposed. According to this approach, underflow is raised when two conditions are simultaneously met. First, the overall value of the data (x_overal), which takes into account the effect of the shared block scaler, must fall within the range-2\hat{ }minV<x_overal<2\hat{ }minV. Second, a rounding error must occur, indicated by a non-zero value.

The parameter in this definition is minV, a threshold that may be determined by the user or application. This flexibility allows for adaptation to various use cases and computational requirements within the MX format framework. Table 6 provides example options for determining the minV value, each with its own rationale and implications.

TABLE 6

| Options | minV | Description |
|---|---|---|
| 1 | −127 | Taken from the minimum of the |
| | | unbiased shared block scaler |
| 2 | −126 | Taken from underflow def of FP32 |
| 3 | −127 + emin | Lowest block scale and lowest |
| | | data element exponent. |

As shown in Table 6, the first example option sets minV to −127, derived from the minimum of the unbiased shared block scaler. The second example option uses −126, aligning with the underflow definition of FP32 for consistency with traditional floating-point representations. The third example option combines the lowest block scale with the lowest data element exponent, expressed as −127+emin.

It is contemplated herein that variations and modifications are possible within the scope of the disclosed subject matter. The disclosed subject matter works for every MX types stated in the standard which are MX4, MX6, or MX8 but may be expanded to any MXk format where k may be any number. MX block size that is mentioned in the standard may be a block of 32 but the disclosed may work for any block size of any 1-dimension and 2-dimension block sizes.

Methods, systems, or apparatus with regard to detecting underflow in a micro-scaling (MX) format are disclosed herein. A method, system, or apparatus may provide for determining an overall value of a data element, considering effects of a shared block scaler; comparing the overall value to a minimum threshold value; determining that a rounding error has occurred; determining an underflow indication when the absolute value of the overall value is less than two times the minimum threshold value and the rounding error has occurred; and sending an indication of the underflow. The minimum threshold value may be determined based on a minimum unbiased shared block scaler value. Alternatively, the minimum threshold value may be determined based on an underflow definition for a 32-bit floating point format. In another variation, the minimum threshold value may be determined based on a lowest block scale value and a lowest data element exponent value. The minimum threshold value may be configurable by a user or application. All combinations (including the removal or addition of steps) in this paragraph or previous paragraphs are contemplated in a manner that is consistent with the other portions of the detailed description.

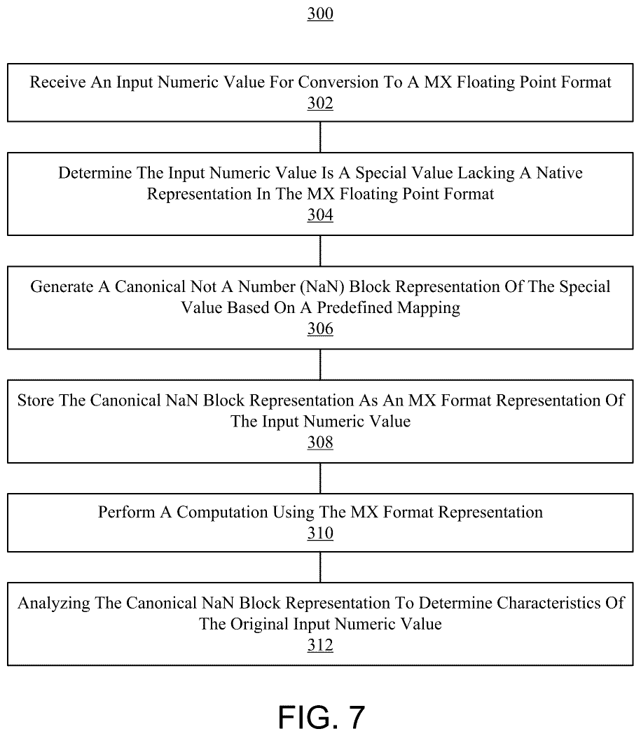

FIG. 7 illustrates an example method 300 for debuggability of MX formats using canonical NaN block representations. At step 302, an input numeric value is received for conversion to an MX format. At step 304, the method determines if the input value is a special value like NaN or infinity that lacks a native representation in the target MX format.

If the input is a special value, at step 306 a canonical NaN block representation is generated based on predefined mappings. For example, different bit patterns within the NaN block can be used to encode whether the original value was NaN, positive infinity, negative infinity, etc. At step 308, the canonical NaN block is stored as the MX format representation.

If the input is not a special value, normal MX format conversion is performed at step 310. The resulting MX format data is then used for computations.

During debugging, at step 312 NaN blocks are analyzed to extract the encoded canonical information. This allows the debugger to determine the original nature of values before MX conversion, aiding in tracking down issues.

Table 7 provides a comprehensive representation of the canonical format examples for the MX4 format as described in the disclosed subject matter. Table 7 is structured with columns that offer detailed information about the conversion process. The “Block NaN” column indicates that the entire block is set to NaN, which is represented by the value 1 across all rows. The “Source Inputs” column displays the original special numeric case or value type that is being converted. The “Source to MX4 Conversion” column illustrates how these inputs are encoded in the MX4 format NaN block. This column includes the resulting value, which is always NaN in this case, as well as the specific encoding used to represent the original input. It also provides the bit pattern for Sign(S), Exponent (E), and Trailing significand (T), along with the hexadecimal representation of the encoding. As detailed in Table 7, there is a demonstration of how various special numeric cases and normal numbers are uniquely encoded within NaN blocks in the MX4 format. This unique encoding scheme may allow for improved debuggability and data interpretation, as it preserves information about the original values even when they cannot be directly represented in the MX4 format.

TABLE 7

| Block | Source | |
|---|---|---|
| NaN | Inputs | Source to MX4 Conversion |
| 1 | NaN | Value: NaN, Encoding: debug_NaN |
| | | (S = 1′b0, E = 2′b11, T = 1′b1) (0x7) |
| 1 | +inf | Value: NaN, Encoding: debug_inf |
| | | (S = 1′b0, E = 2′b11, T = 1′b0) (0x6) |
| 1 | −inf | Value: NaN, Encoding: debug_inf |
| | | (S = 1′b1, E = 2′b11, T = 1′b0) (0xE) |
| 1 | zero | Value: NaN, Encoding: debug_zero |
| | | (S = 1′b0, E = 2′b00, T = 1′b0) (0x0) |
| 1 | Normal | Value: NaN, Encoding: debug_normal |
| | | (S = 1′b0, E = 2′b01, T = 1′b0) (0x2) |

The disclosed subject matter has multiple potential applications across multiple domains. In large language model training, utilizing MX formats with the ability to track special values throughout the training process may aid in identifying numerical instability issues. For computer vision applications, image processing pipelines using MX formats may benefit from preserved NaN block information to debug artifacts or unexpected results. In scientific computing, simulations leveraging MX formats for performance can use canonical NaN blocks to verify proper propagation of infinities or NaNs. When emulating AI hardware designs, the enhanced debuggability facilitates easier verification of correct handling of special cases. Additionally, compilers targeting MX formats may leverage the canonical representations to implement more sophisticated optimizations while preserving numerical semantics.

The disclosed concepts may differ from conventional implementations. For example, numerical debugging capabilities for MX format computations, reduced time required to identify and resolve numerical issues in AI workloads, enhanced visibility into data transformations and special value propagation, or more robust handling of edge cases in low-precision AI computations.

To further enhance usability, the canonical NaN block representations can be automatically generated and inserted by numeric libraries or compilers when converting to MX formats in some implementations. This approach facilitates integration into existing workflows and systems.

The disclosed subject matter works for every MX types stated in the standard which are MX4, MX6, or MX8 but may be expanded to any MXk format where k may be any number. MX block size that is mentioned in the standard may be a block of 32 but the disclosed may work for any block size of any 1-dimension and 2-dimension block sizes.

Methods, systems, or apparatus with regard to debuggability of Micro-scaling Numerics (MX) format data are disclosed herein. A method, system, or apparatus may provide for defining canonical values for representing special numeric cases within NaN blocks in MX format data; identifying source data that cannot be directly represented in a target MX format; mapping the identified source data to the defined canonical values; and storing the mapped data in NaN blocks of the target MX format. The special numeric cases may include infinity (Inf), Not a Number (NaN), zero, or normal numbers that cannot be directly represented in the target MX format. The canonical values and mapping of source data to canonical values may be user-defined. All combinations (including the removal or addition of features) in this paragraph and the above paragraphs are contemplated in a manner that is consistent with the other portions of the detailed description.

Methods, systems, or apparatus may include creating a NaN block by setting a data block (e.g., the entire data block) to represent NaN when at least one element in the source data cannot be directly represented in the target MX format. The target MX format may be MX4 format. When the source data is NaN, positive infinity, negative infinity, zero, or a normal number that cannot be represented in MX4, the method may involve creating a NaN block and encoding it with appropriate debug values (debug_NaN, debug_inf with positive or negative sign, debug_zero, or debug_normal). The method may include encoding NaN blocks with debug values that indicate the type of special numeric case or non-representable normal number from the source data. All combinations (including the removal or addition of features) in this paragraph and the above paragraphs are contemplated in a manner that is consistent with the other portions of the detailed description.

Methods, systems, or apparatus may include defining canonical values for special numeric cases in MX format data; mapping source data to the defined canonical values; and storing the mapped data in NaN blocks of the MX format. Additionally, the method may include defining a canonical format that represents which members of a block were NaN before conversion to MX format. All combinations (including the removal or addition of features) in these paragraphs are contemplated in a manner that is consistent with the other portions of the detailed description. These methods allow for improved debugging and representation of special cases in MX format data, which can be particularly useful in applications involving complex numerical computations or data processing tasks. All combinations (including the removal or addition of features) in this paragraph and the above paragraphs are contemplated in a manner that is consistent with the other portions of the detailed description.

A method, system, or apparatus may provide for receiving an input numeric value for conversion to a MX floating point format; determining the input numeric value is a special value lacking a native representation in the MX floating point format; generating a canonical Not a Number (NaN) block representation of the special value based on a predefined mapping; storing the canonical NaN block representation as an MX format representation of the input numeric value; performing a computation using the MX format representation; and during debugging, analyzing the canonical NaN block representation to determine characteristics of the original input numeric value. All combinations (including the removal or addition of features) in these paragraphs are contemplated in a manner that is consistent with the other portions of the detailed description.

A method, system, or apparatus may include receiving a non-special numeric value; performing normal MX format conversion for the non-special numeric value; and storing a result of the normal MX format conversion. Generating the canonical NaN block representation may include encoding an indication of whether the input numeric value was NaN, positive infinity, or negative infinity prior to conversion. The method may also include customizing the predefined mapping based on application requirements. The ability to analyze the canonical NaN block representation during debugging provides valuable insights into the characteristics of the original input numeric values, enhancing the debuggability of MX format data. All combinations (including the removal or addition of features) in these paragraphs are contemplated in a manner that is consistent with the other portions of the detailed description.

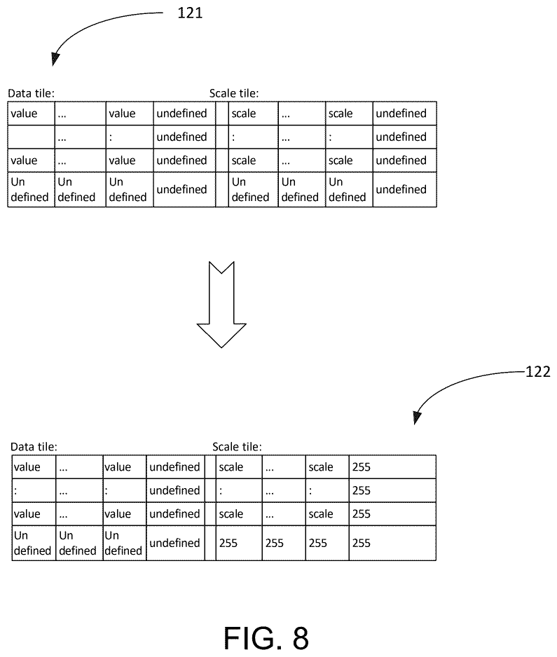

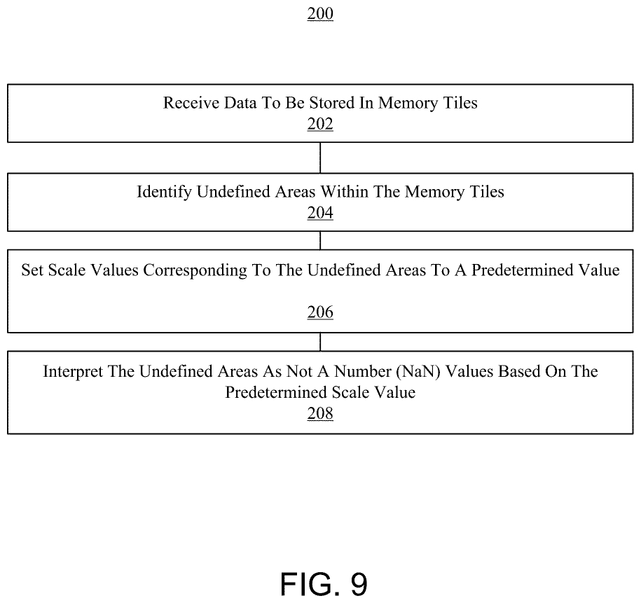

FIG. 8 illustrates an example of the disclosed approach as further described in FIG. 9 and other approaches. The approach may help the management undefined memory areas in MX floating point formats. As shown in the FIG. 8, there is a comparison between a data tile structure 121 and a disclosed change with data tile structure 122. In the data tile structure 121, there are undefined areas within the memory tiles, both in the data and scale sections. These undefined areas pose potential risks for data interpretation and usage. The data tile structure 122 may address this issue. Instead of leaving these areas undefined, data tile structure 122 sets the corresponding scale values of the undefined memory space to a specific value, in this case, 255. This technique effectively marks these areas as including Not a Number (NaN) values, thereby preventing misinterpretation or misuse of the undefined memory regions. This may safeguard against potential errors. The efficiency of this approach may be attributed to the fact that the scale size represents a relatively small portion of the overall MX data format. By implementing this strategy, there may be protection against mistakes that might arise from accessing or interpreting undefined memory areas, while maintaining the performance benefits of the MX floating point format commonly used in machine learning applications.

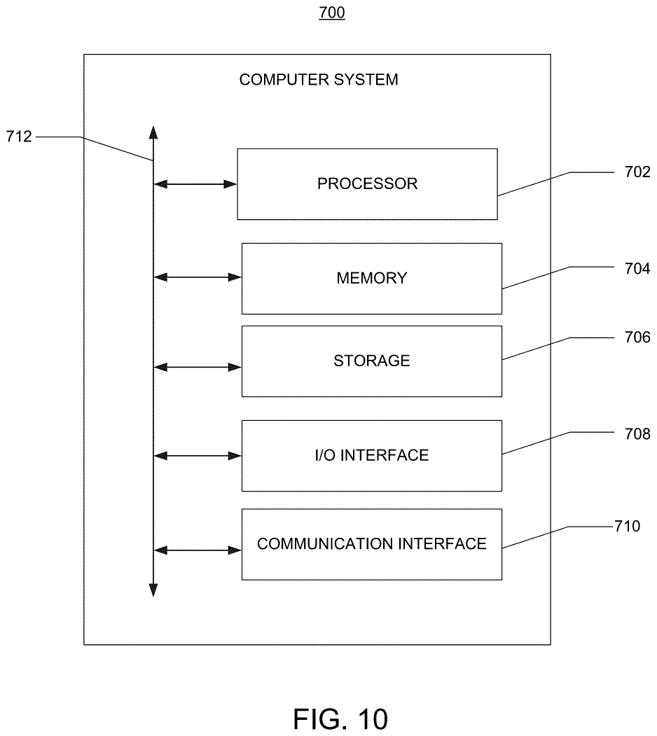

FIG. 9 is a method flow of an example method 200 for handling special values in a block-based floating point format. The methods herein may be incorporated using hardware or software, as disclosed herein, such as system 700 of FIG. 10. At step 202, a block of data elements in a block-based floating point format may be received. This block may include a shared block scaling factor and multiple data elements.

At step 204, it may be determined whether the shared block scaling factor indicates that the block includes at least one special value. In some embodiments, this may involve checking if the shared block scaling factor has a specific value, such as 255 for an 8-bit scaling factor.

If the block is determined to include special values, the method may proceed to step 206. For each data element in the block, a canonical bit pattern may be assigned based on whether the data element represents a normal value, zero, infinity, or NaN. These canonical bit patterns may be predefined for each data element type.

At step 208, the block is stored with the assigned canonical bit patterns for the data elements. This may allow for efficient storage and later analysis of the special values within the block structure. The canonical bit patterns may be defined as follows as shown in Table 8.

TABLE 8

Normal value: 0b0000 (example for 4-bit data element)
Zero: 0b0001
Infinity: 0b0010
NaN: 0b0011

These patterns are examples and may be adjusted based on the specific implementation and data element size. The disclosed techniques may allow for efficient identification and analysis of special values within block-based floating point formats. This may aid in debugging and understanding the behavior of computations using these formats.

The techniques may maintain the block structure and potential performance benefits of the block-based formats while adding the ability to handle special values effectively. In addition, the disclosed techniques may be useful in machine learning applications, where block-based floating point formats are increasingly used for performance reasons.

It is contemplated herein that variations and modifications are possible within the scope of the disclosed subject matter. For example, the size of the block, the number of data elements per block, or the specific bit patterns used for canonical representations may vary depending on the implementation. The disclosed subject matter works for every MX type stated in the standard which are MX4, MX6, or MX8 but may be expanded to any MXk format where k may be any number. MX block size that is mentioned in the standard may be a block of 32 but the disclosed may work for any block size of any 1-dimension and 2-dimension block sizes.

Methods, systems, or apparatus with regard to managing memory and handling special values in block-based floating point formats, such as MicroXcaling (MX) formats, are disclosed herein. A method, system, or apparatus may provide for receiving data to be stored in memory tiles; identifying undefined areas within the memory tiles; setting scale values corresponding to the undefined areas to a predetermined value, such as 255; and interpreting the undefined areas as Not a Number (NaN) values based on the predetermined scale value. This approach may protect against misinterpretation of undefined memory areas. The method may further involve storing defined data values in defined areas of the memory tiles along with corresponding scale values for the defined data values. All combinations (including the removal or addition of features) in these paragraphs are contemplated in a manner that is consistent with the other portions of the detailed description.

In a related aspect, a method for packing data in memory for MX floating point formats may include receiving data to be packed into memory tiles; packing the data into memory tiles matching hardware resource sizes; padding partial data within MX blocks to a block size (e.g., 32) with zero values; setting a scaling factor for regions outside partial tiles to a defined value (e.g., 255); and interpreting the regions outside partial tiles as NaN values based on the scaling factor. All combinations (including the removal or addition of features) in these paragraphs are contemplated in a manner that is consistent with the other portions of the detailed description.

Methods, systems, or apparatus with regard to handling special values in block-based floating point formats are disclosed herein. A method, system, or apparatus may provide for receiving a block of data elements in a block-based floating point format, wherein the block includes a shared block scaling factor and multiple data elements; determining that the shared block scaling factor indicates the block includes at least one special value; for each data element in the block, assigning a canonical bit pattern to represent the data element based on whether the data element represents a normal value, zero, infinity, or not-a-number (NaN); and storing the block with the assigned canonical bit patterns for the data elements. The block-based floating point format may be a MicroXcaling (MX) format. The shared block scaling factor may be 8 bits, and determining that it indicates the block includes at least one special value may comprise determining the shared block scaling factor has a value of 255. All combinations (including the removal or addition of features) in these paragraphs are contemplated in a manner that is consistent with the other portions of the detailed description.

The canonical bit patterns may be predefined for each data element type. Assigning the canonical bit pattern may include assigning a first predefined bit pattern to represent normal value data elements, a second predefined bit pattern to represent zero value data elements, a third predefined bit pattern to represent infinity value data elements, and a fourth predefined bit pattern to represent NaN value data elements. The method may further comprise analyzing the stored block to identify which data elements represent special values based on their assigned canonical bit patterns. The block may include 32 data elements. Each data element may include a sign bit, an exponent field, and a trailing significand field. All combinations (including the removal or addition of features) in these paragraphs are contemplated in a manner that is consistent with the other portions of the detailed description.

FIG. 10 illustrates an example computer system 700 which may incorporate machine learning, such as generative artificial intelligence. System 700 may implement solely or in combination with other computing devices the methods herein. In examples, one or more computer systems 700 perform one or more steps of one or more methods described or illustrated herein. In particular embodiments, one or more computer systems 700 provide functionality described or illustrated herein. In examples, software running on one or more computer systems 700 performs one or more steps of one or more methods described or illustrated herein or provides functionality described or illustrated herein. Examples include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In examples, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In examples, processor 702 includes hardware for executing instructions, such as those making up a computer program. As an example, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In examples, memory 704 includes main memory for storing instructions for processor 702 to execute or data for processor 702 to operate on. As an example, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In examples, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In examples, storage 706 includes mass storage for data or instructions. As an example, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In examples, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In examples, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In examples, communication interface 710 includes hardware, software, or both providing one or more interfaces for communication (such as, for example, packet-based communication) between computer system 700 and one or more other computer systems 700 or one or more networks. As an example, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

System 700 may include one or more hardware components that read and processes the MX format data stored in memory. This may be a neural network accelerator, a tensor processing unit, or any other specialized hardware designed to perform computations on MX format data. The one or more hardware components may be designed with specific read capabilities in mind, which inform the tiled format structure used for storing the MX data and/or the one or more hardware components may be designed with specific read capabilities in mind, which inform the tiled format structure used for storing the MX datahandling of special values in block-based floating point formats.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of a robotic skin or AI robotics platform, among other things as disclosed herein. For example, one skilled in the art will recognize that robotic skin or AI robotics platform, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—handling micro-scaling numerics (MX) format data in memory and/or special values in block-based floating point formats—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method for storing micro-scaling numerics (MX) format data in memory, comprising:
interleaving scaling data with floating point data associated with MX data;
storing the floating point data in raster scan order; and
storing the scaling data in sub-tiles packed in multiples of a memory line size.

2. The method of claim 1, further comprising:
maintaining a constant product of tile x-size and format size across different MX format sizes.

3. The method of claim 1, further comprising accessing the MX data based on the storing of the floating point data and the storing of the scaling data.

4. The method of claim 1, wherein the tiled formats comprise an x-size and a y-size that are multiples of block-tiles supported by a consuming hardware block.

5. The method of claim 4, wherein the block-tiles are multiples of an MX block format size.

6. The method of claim 1, wherein the memory line size is 64 bytes.

7. The method of claim 1, further comprising:
defining a smallest unit of memory supported by a consuming hardware block as a block-tile.

8. The method of claim 1, wherein a product of tile x-size and format size remains constant by adjusting the x-size inversely to changes in format size.

9. A method for storing micro-scaling numerics (MX) format data in memory, comprising:
organizing MX data into tiled formats matching read capabilities of a consuming hardware block;
interleaving scaling data with floating point data associated with the MX data;
storing the floating point data in raster scan order, and
storing the scaling data in sub-tiles packed in multiples of a memory line size.

10. A method comprising:
receiving data; and
storing the received data in a micro-scaling numerics (MX) format, wherein the MX format tiled format matches the read capability of a consuming block, wherein scaling data is interleaved with floating point data associated with the received data.
